(19) United States
(12) Patent Application Publication
(10) Pub. No.: US 2024/0399252 A1
(43) Pub. Date: Dec. 5, 2024

(54) METHOD AND APPARATUS FOR DISPLAYING MARK INFORMATION, STORAGE MEDIUM, AND ELECTRONIC DEVICE

(71) Applicant: Tencent Technology (Shenzhen) Company Limited, Shenzhen (CN)

(72) Inventors: Ziyi WANG, Shenzhen (CN); Shuai JIANG, Shenzhen (CN); Chenghao YE, Shenzhen (CN); Guangxin WANG, Shenzhen (CN); Wenbo LIN, Shenzhen (CN); Meng LIANG, Shenzhen (CN)

(21) Appl. No.: 18/803,308

(22) Filed: Aug. 13, 2024

Related U.S. Application Data
(63) Continuation of application No. PCT/CN2023/133512, filed on Nov. 23, 2023.

(30) Foreign Application Priority Data
Dec. 29, 2022 (CN) 202211711919.2

(51) Int. Cl. A63F 13/5372; A63F 13/533; A63F 13/5378; A63F 13/56

(52) U.S. Cl. CPC A63F 13/5372; A63F 13/533; A63F 13/5378; A63F 13/56

(57) ABSTRACT

The present disclosure provides a method for displaying mark information performed by a computer device. The method includes: determining that a first virtual object controlled by a user of the computer device participates in a game task; displaying a preparation interface before the first virtual object enters a virtual game scene configured for the game task; after a target scene point in the virtual game is marked, displaying entry prompt information matching the target scene point in the preparation interface; and in response to an operation performed on an invitation control matching the target scene point, transmitting first entry invitation information to a second virtual object participating in the game task, the first entry invitation information including the target scene point for the second virtual object to follow the first virtual object in the game task.

### CROSS-REFERENCE TO RELATED APPLICATIONS

This application is a continuation application of PCT Patent Application No. PCT/CN2023/133512, entitled “METHOD AND APPARATUS FOR DISPLAYING MARK INFORMATION, STORAGE MEDIUM, AND ELECTRONIC DEVICE” filed on Nov. 23, 2023, which claims priority to Chinese Patent Application No. 202211711919.2, entitled “METHOD AND APPARATUS FOR DISPLAYING MARK INFORMATION, STORAGE MEDIUM, AND ELECTRONIC DEVICE” and filed with the China National Intellectual Property Administration on Dec. 29, 2022, both of which are incorporated herein by reference in their entirety.

### FIELD OF THE TECHNOLOGY

This application relates to the field of computers, and specifically, to a method and an apparatus for displaying mark information, a storage medium, and an electronic device.

### BACKGROUND OF THE DISCLOSURE

In an existing multiplayer battle game, a plurality of players in the same camp may mark points on a game map from a game preparation stage to a moment at which a game officially starts, and other teammates may be told, through the points marked on the map, that: This is where I want to go. After marking the points, the players may further invite other teammates to follow the marked points. In this way, it can be ensured that the teammates are all in the same virtual game scene after the game starts.

In a current game, after a current player marks points, the player does not know whether other players can receive information about the marked points, and processes of marking points and parachuting in the current game are independent. If the player wants to initiate an invitation after marking points or to request a follow after receiving information about the marked points from other teammates, a lot of steps need to be clicked, which is cumbersome and inefficient. In other words, in the related art, there is a technical problem of low display efficiency of mark information in the game preparation stage.

In view of the foregoing problem, no effective solution has been provided yet.

### SUMMARY

Embodiments of this application provide a method and an apparatus for displaying mark information, a storage medium, and an electronic device, to resolve at least a technical problem in low display efficiency of the mark information in the related art.

According to an aspect of the embodiments of this application, a method for displaying mark information is performed by a computer device, including: determining that a first virtual object controlled by a user of the computer device participates in a game task; displaying a preparation interface before the first virtual object enters a virtual game scene configured for the game task, the preparation interface including a scene map corresponding to the virtual game scene; after a target scene point in the scene map is marked, displaying entry prompt information matching the target scene point in the preparation interface, the entry prompt information providing an entry position for the first virtual object to enter the virtual game scene and a task confrontation policy matching the entry position; and in response to an operation performed on an invitation control matching the target scene point, transmitting first entry invitation information to a second virtual object participating in the game task, the first entry invitation information including the target scene point for the second virtual object to follow the first virtual object in the game task.

According to another aspect of the embodiments of this application, a non-transitory computer-readable storage medium is further provided, the computer-readable storage medium having a computer program stored therein, and the computer program, when executed by a processor of a computer device, causing the computer device perform the foregoing method for displaying mark information.

According to still another aspect of the embodiments of this application, an electronic device is further provided. The electronic device includes a memory and a processor, the foregoing memory having a computer program stored therein, and the computer program, when executed by the processor, causing the computer device to perform the foregoing method for displaying mark information through the foregoing computer program.

In the embodiments of this application, when a target scene point is marked in a scene map in a preparation interface of a first virtual object, corresponding entry prompt information is generated and prompted, and invitation information is transmitted to another virtual object in response to a transmitting operation, so that mark information is transmitted to the another virtual object in the form of an invitation, ensuring that another virtual object can receive mark information of a current player. In addition, a display operation and an invitation operation of the mark information are simplified, a technical problem of low display efficiency of the mark information in an existing game preparation stage is resolved, and a technical effect of improving the display efficiency of the mark information is achieved.

### BRIEF DESCRIPTION OF THE DRAWINGS

The accompanying drawings described herein are used to provide a further understanding of embodiments of this application, and form a part of this application. Exemplary embodiments of this application and descriptions thereof are used to explain this application, and do not constitute any inappropriate limitation to this application. In the accompanying drawings:

FIG. 1 is a schematic diagram of a hardware environment of a method for displaying mark information according to an embodiment of this application.

FIG. 2 is a flowchart of a method for displaying mark information according to an embodiment of this application.

FIG. 3 is a schematic diagram of a method for displaying mark information according to an embodiment of this application.

FIG. 4 is a schematic diagram of a hardware environment of another method for displaying mark information according to an embodiment of this application.

FIG. 5 is a schematic diagram of still another method for displaying mark information according to an embodiment of this application.

FIG. 6 is a schematic diagram of still another method for displaying mark information according to an embodiment of this application.

FIG. 7 is a schematic diagram of still another method for displaying mark information according to an embodiment of this application.

FIG. 8 is a schematic diagram of still another method for displaying mark information according to an embodiment of this application.

FIG. 9 is a schematic diagram of still another method for displaying mark information according to an embodiment of this application.

FIG. 10 is a schematic diagram of still another method for displaying mark information according to an embodiment of this application.

FIG. 11 is a schematic diagram of still another method for displaying mark information according to an embodiment of this application.

FIG. 12 is a flowchart of another method for displaying mark information according to an embodiment of this application.

FIG. 13 is a flowchart of another method for displaying mark information according to an embodiment of this application.

FIG. 14 is a schematic structural diagram of an apparatus for displaying mark information according to an embodiment of this application.

FIG. 15 is a schematic structural diagram of an electronic device according to an embodiment of this application.

### DESCRIPTION OF EMBODIMENTS

To make a person skilled in the art better understand the solutions in this application, the following clearly and completely describes the technical solutions in embodiments of this application with reference to the accompanying drawings in the embodiments of this application. Apparently, the described embodiments are only some embodiments rather than all the embodiments of this application. All other embodiments obtained by a person of ordinary skill in the art based on the embodiments of this application without creative efforts shall fall within the protection scope of this application.

In the specification, claims, and accompanying drawings of this application, the terms “first”, “second”, and the like are intended to distinguish between similar objects but do not necessarily indicate a specific order or sequence. Data used in such a way is interchangeable in proper circumstances, so that the embodiments of this application described herein can be implemented in other orders than the order illustrated or described herein. In addition, the terms “comprise”, “include”, and any other variants thereof mean to cover non-exclusive inclusion. For example, a process, method, system, product, or device that includes a series of operations or units is not necessarily limited to those expressly listed operations or units, but may include other operations or units not expressly listed or inherent to the process, method, product, or device.

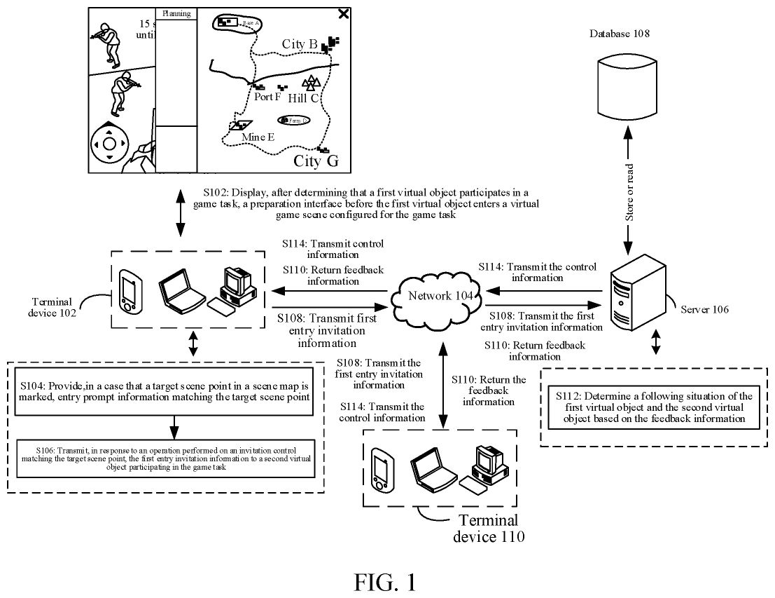

According to an aspect of the embodiments of this application, a method for displaying mark information is provided. In an implementation, the method for displaying mark information may be applicable to, but is not limited to, a system for displaying mark information in a hardware environment shown in FIG. 1. The system for displaying mark information may include, but is not limited to, a terminal device 102, a network 104, a server 106, a database 108, and a terminal device 110. The terminal device 102 and the terminal device 110 each run an application client (as shown in FIG. 1, that the application client is a game application client is used as an example). The foregoing terminal device 102 and terminal device 110 each include a human-computer interaction screen, a processor, and a memory. The human-computer interaction screen is configured to display a virtual game scene (for example, the virtual game scene shown in FIG. 1), and also to provide a human-computer interaction interface, to receive a human-computer interaction operation for controlling a virtual object in a virtual scene, thereby controlling the virtual object to complete a game task set in the virtual scene. The processor is configured to generate interaction instructions in response to the foregoing human-computer interaction operation, and send the interaction instructions to the server. The memory is configured to store related attribute data, for example, object attribute information of a controlled virtual object, and attribute information of a held virtual item. The attribute information herein may include, but is not limited to, information configured for identifying an identity and a current position of an object or an item. A client controlling a first virtual object runs in the terminal device 102. When a second virtual object is a virtual object controlled by the terminal device 110, the terminal device 110 runs a client controlling the second virtual object. The second virtual object and the first virtual object herein may be controlled to perform an interaction event in a game, for example, an attack event, a defense event, or a skill release event.

In addition, the server 106 includes a processing engine, and the processing engine is configured to perform a storage or reading operation on the database 108. Specifically, the processing engine reads virtual scene information of each virtual object and operation information performed on the virtual object from the database 108. It is assumed that the terminal device 102 in FIG. 1 is configured to control the first virtual object, and the terminal device 110 is configured to control the second virtual object in the same game task. A specific process of this embodiment includes the following operation S102 to operation S114. In operation S102 to operation S106, after it is determined that the first virtual object participates in the game task, a preparation interface before the first virtual object enters a virtual game scene configured for the game task is displayed, where a scene map corresponding to the virtual game scene is displayed in the preparation interface; entry prompt information matching a target scene point is prompted when the target scene point in the scene map is marked, where the entry prompt information is configured for providing an entry position when the first virtual object enters the virtual game scene, and a task confrontation policy matching the entry position; and in response to an operation performed on an invitation control matching the target scene point, first entry invitation information is transmitted to the second virtual object participating in the game task, where the first entry invitation information is configured for inviting the second virtual object to follow the first virtual object into the virtual game scene. Next, in operation S108, the terminal device 102 transmits the first entry invitation information to the server 106 and the terminal device 110 through the network 104. The terminal device 110 performs operation S110, and returns feedback information to the server 106 and the terminal device 102 through the network 104, where the feedback information is configured for indicating whether the second virtual object accepts the first entry invitation information. Then, in operation S112, the server 106 determines a following situation of the first virtual object and the second virtual object based on the feedback information. In operation S114, the server 106 transmits control information to the terminal device 102 and the terminal device 110 through the network 104, where the control information is configured for controlling the first virtual object and the second virtual object to enter the game scene based on the following situation. When the second virtual object follows the first virtual object, the second virtual object is controlled to follow the first virtual object to enter a marked target scene point; or when the second virtual object does not follow the first virtual object, the second virtual object and the first virtual object are respectively controlled to enter respective selected virtual scenes.

In another implementation, the foregoing operation S112 may be performed by the terminal device 102 or the terminal device 110 when the terminal device 102 or the terminal device 110 has powerful computing processing capability. The implementations described herein are an examples, and are not limited in the embodiments of this application.

In an embodiment, the foregoing terminal device may be a terminal device provided with an application client, and may include, but is not limited to, at least one of the following: a mobile phone (for example, an Android mobile phone or an iOS mobile phone), a notebook computer, a tablet computer, a palmtop computer, a mobile Internet device (MID), a PAD, a desktop computer, or a smart TV. The application client may be a client supporting a game task such as a video client, an instant messaging client, a browser client, or an education client. The foregoing network may include, but is not limited to: a wired network and a wireless network. The wired network includes: a local area network, a metropolitan area network, and a wide area network. The wireless network includes: a Bluetooth, a Wi-Fi, and another network implementing wireless communication. The foregoing server may be a single server or a server cluster that includes a plurality of servers, or a cloud server. The foregoing is merely an example, and this is not limited in the embodiments of this application.

In an embodiment, the foregoing method for displaying mark information may be, but is not limited to, applicable to a game-type terminal application (APP for short) that completes a predetermined confrontation game task in a virtual scene, for example, a virtual confrontation game application in a multilayer online battle arena (MOBA) application. The foregoing confrontation game task may be, but is not limited to, a game task completed through confrontation interaction between a virtual object in a virtual scene controlled by a current player through human-computer interaction operations and a virtual object controlled by another player. The foregoing method for displaying mark information may also be applicable to a terminal application of a type of a massive multiplayer online role-playing game (MMORPG for short). In this type of game, the current player may complete a social game task in a game at a first viewing angle of a virtual object in a role-playing manner, for example, complete a game task in combination with another virtual object. The social game task herein may be, but is not limited to, running in an application (for example, a non-independently running game APP) in a form of a plug-in, an applet, or the like, or running in a game engine (for example, an independently running game APP). The type of the foregoing game application may include, but is not limited to, at least one of the following: a two-dimensional (2D) game application, a three-dimensional (3D) game application, a virtual reality (VR) game application, an augmented reality (AR) game application, or a mixed reality (MR) game application. The foregoing is merely an example, and this is not limited in the embodiments of this application.

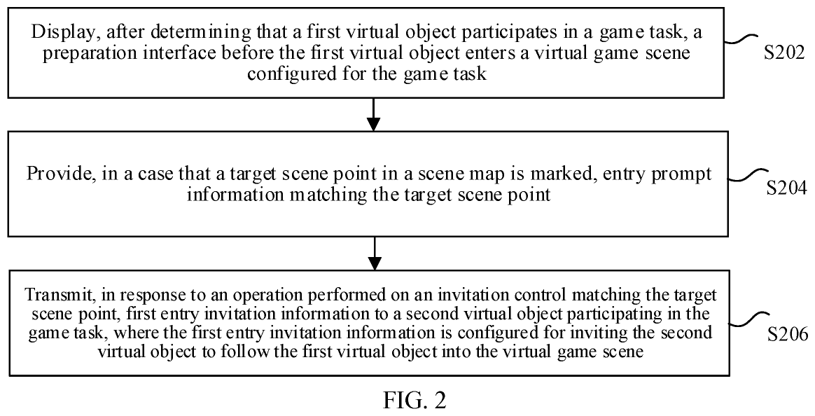

In an implementation, as shown in FIG. 2, the foregoing method for displaying mark information includes the following operation S202 to operation S206.
S202: Display, after determining that a first virtual object participates in a game task, a preparation interface before the first virtual object enters a virtual game scene configured for the game task, where a scene map corresponding to the virtual game scene is displayed in the preparation interface.
S204: Provide, when a target scene point in the scene map is marked, entry prompt information matching the target scene point, where the entry prompt information is configured for providing an entry position when the first virtual object enters the virtual game scene, and a task confrontation policy matching the entry position.
S206: Transmit, in response to an operation performed on an invitation control matching the target scene point, first entry invitation information to a second virtual object participating in the game task, where the first entry invitation information is configured for inviting the second virtual object to follow the first virtual object into the virtual game scene.

In operation S202, the foregoing first virtual object may be a virtual character, a virtual image, or a virtual person controlled by a player in a game. In an embodiment, the player may control the first virtual object to mark the target scene point in the virtual scene map by the method in the foregoing operation, and transmit the first entry invitation information to the second virtual object in response to the operation performed on the invitation control.

The foregoing game task may be a multiplayer battle game task, where the multiplayer battle game task may be a game task in which grouping of game battle teams is performed in advance, that is, virtual objects belonging to different game battle teams have been determined before the game starts, and virtual objects in the same game battle team win the game by defeating virtual objects of another battle team in the game task. In an embodiment, the multiplayer battle game task may alternatively be a game task in which the grouping of game battle teams is not performed in advance, and a plurality of virtual objects participating in the game task can freely form teams after the game starts, and perform a game battle in units of temporarily formed game battle teams. In a first stage of the game, virtual objects in another team can be defeated in units of battle teams, and in a second stage of the game, it is necessary to defeat all other virtual objects in the game task to win the game. The form of the foregoing multiplayer battle game is merely an example and does not limit the form of the game used in an actual multiplayer battle game.

In the foregoing multiplayer game battle task, all game players may first enter the same initial virtual scene to perform corresponding operations in the game preparation stage, for example, changing virtual clothing and virtual decorations of a virtual object in the game task, and may also perform related operations such as game policy arrangement in the game preparation stage, for example, selecting a target virtual scene as an initial scene of the game and selecting a target game policy as an initial action plan of the game. The foregoing preparation interface may be a game operation interface corresponding to the first virtual object in the game preparation stage, and the game operation interface may include the virtual game scene and the scene map corresponding to the virtual game scene.

The foregoing scene map is further described below. The foregoing scene map may include, but is not limited to, two types of scene maps. A first type of scene map may be a minimap displayed at an upper right corner of the preparation interface, and a game scene range displayed on the minimap corresponds to the virtual game scene in which the first virtual object is located. A second type of scene map may include a large map displayed on a right side of the preparation interface, and a game scene range displayed on the large map corresponds to all game scenes corresponding to an entire game task.

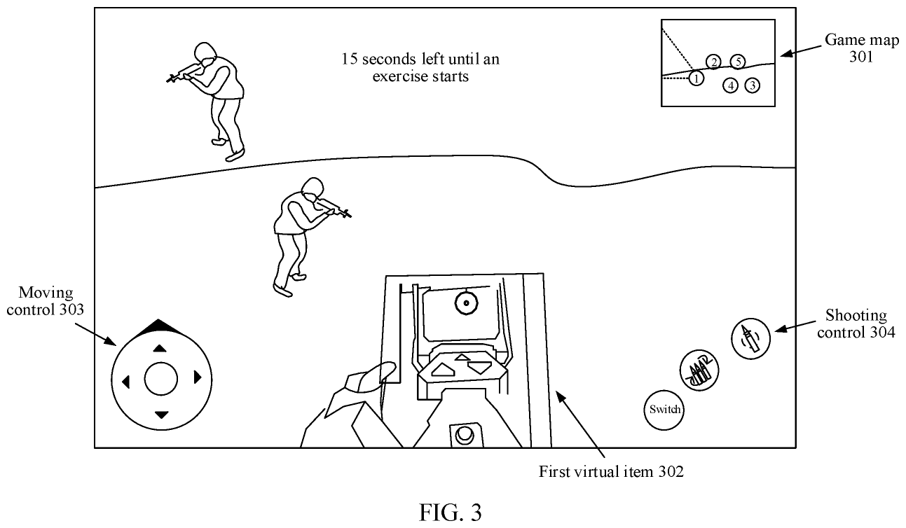

FIG. 3 is a schematic diagram of an interface of a game preparation interface. A game map 301 shown in FIG. 3 is a scene map in a form of a minimap, and the game map 301 displays object identifiers of a plurality of virtual objects in the same camp as the first virtual object, and a thumbnail corresponding to a game scene in which the first virtual object is currently located. For example, object identifiers “1”, “2”, “3”, “4”, and “5” of the plurality of virtual objects in the same camp as the first virtual object are shown in the game map 301. In addition, preparation prompt information “15 seconds left until the exercise starts” is displayed in the preparation interface corresponding to the first virtual object. In addition, the preparation interface further displays a first virtual item 302 for launching attacks to another virtual object in the game task, and displays one or more operation controls. The operation control may include: a moving control 303, configured to control the first virtual object to move in the virtual scene; and a shooting control 304, configured to control to launch attacks to another virtual object through the first virtual item 302. In addition, the operation control may further include a switching control, configured to switch a virtual attack item.

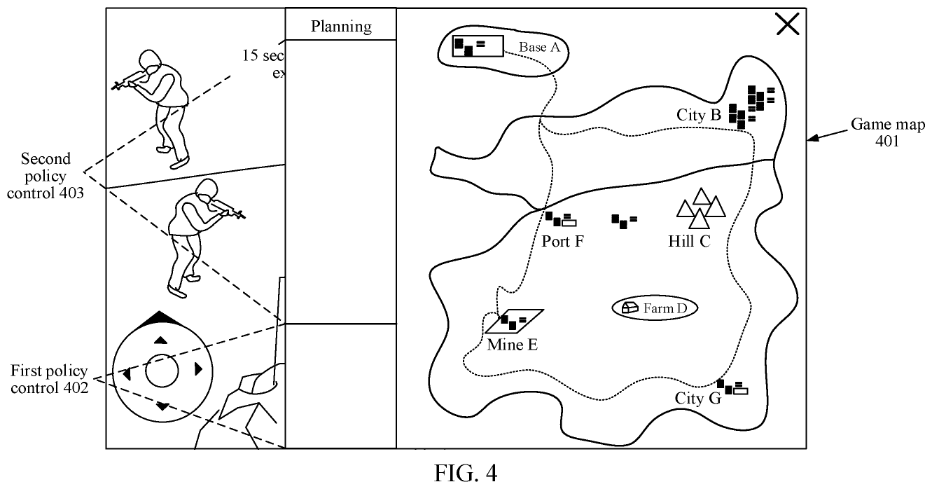

FIG. 4 is a schematic diagram of an interface of another game preparation interface. A game map 401 shown in FIG. 4 is a scene map in a form of a large map, and a scene range displayed on the map corresponds to a game scene corresponding to an entire game task. For example, the game map 401 shows that a scene of the game task includes two different islands, where a small island includes a game scene “Base A”, and game scenes on a large island include “City B”, “Hill C”, “Farm D”, “Mine E”, “Port F”, and “City G”. The game map 401 shows an entire game scene range in which the first virtual object can move in the game task.

In an embodiment, switching may be performed between the first type of scene map and the second type of scene map. For example, in FIG. 3, the game map 401 in FIG. 4 may be switched by clicking the game map 301. In FIG. 4, the game map 301 in FIG. 3 may be returned to display by clicking a cancellation control at an upper right corner of the game map 401. The foregoing switching manner is merely an example, and does not limit a switching manner used in a specific implementation.

For example, in FIG. 4, a planning box is further displayed on a left side of the game map 401, including a first policy control 402 and a second policy control 403, where the first policy control is configured to display game planning information for the first virtual object, and the second policy control is configured to display game planning information for the second virtual object in the same camp as the first virtual object.

Further, in the foregoing operation S204, the game player may control the first virtual object to mark the target scene point in the scene map, to determine a position in the virtual game scene at which the first virtual object arrives for the first time after officially entering the game task. The foregoing prompt information may be related to the target scene point marked in the scene map, and may further include target scene point information and a corresponding task confrontation policy. In an embodiment, when the first virtual object marks the target scene point in the scene map, a marked target scene point may be an entry position of the first virtual object entering the virtual game scene by default.

A correspondence between the entry position and the task confrontation policy matching the entry position may be a preset correspondence. For example, when the task confrontation policy includes “Gather”, “Battle”, and “Develop”, a correspondence between the entry position and the confrontation policy may be “Base A”—“Develop”; “City B”, “City G”, and “Port F”—“Battle”; and “Hill C”, “Mine E”, and “Farm D”—“Gather”. The foregoing preset correspondence is merely an example, and does not limit a specific correspondence set in a specific implementation.

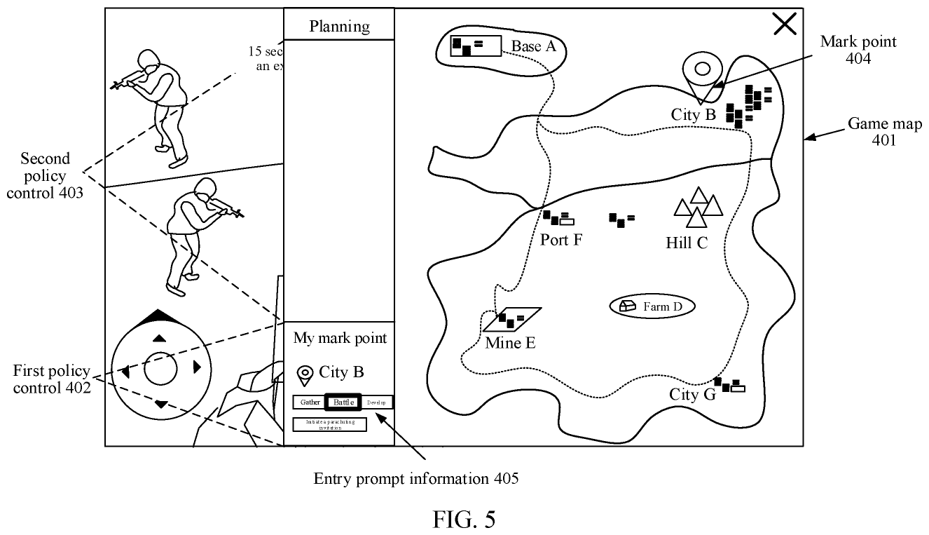

As shown in FIG. 5, when “City B” in the game map 401 is marked as a mark point 404, corresponding entry prompt information 405 may be displayed on the left side of the game map 401, that is, a position corresponding to the first policy control 402. Specific information may include title information “My mark points”, entry position information “City B”, and policy information “Battle” corresponding to the position selected by default.

Further, in the foregoing operation S206, while the entry prompt information is displayed, a corresponding invitation control may be further displayed, and the control corresponds to the marked target scene point. In this way, the first entry invitation information may be transmitted to the second virtual object in response to an operation performed on the invitation control. In an embodiment, the foregoing first entry invitation information is configured for inviting the second virtual object to follow the first virtual object into the virtual game scene corresponding to the marked target scene point.

In an embodiment, when the foregoing game task is a pre-grouped multiplayer battle game task, the second virtual object may be a virtual object in the same camp as the first virtual object. In an implementation, the second virtual object may be a virtual object that is in the same camp as the first virtual object and is in an unlimited following status. In another implementation, the second virtual object may be a virtual object that is in the same camp as the first virtual object and is in a non-following state and a non-invitation-initiated state. The non-following state indicates that the second virtual object does not become a follower of another virtual object, and the non-invitation-initiated state indicates that the second virtual object does not transmit a following invitation to another virtual object. The foregoing manner of defining the second virtual object is merely an example, and does not limit the second virtual object in a specific implementation.

In an embodiment, a correspondence may exist between the first entry invitation information transmitted to the second virtual object and the entry prompt information displayed in operation S204. That is, the foregoing first entry invitation information may include, but is not limited to, an entry position selected by the first virtual object entering the virtual game scene, and a task confrontation policy matching the entry position.

In an embodiment, the foregoing following relationship may be a following relationship established between the second virtual object and the first virtual object when the second virtual object accepts the first entry invitation information. In an implementation, the first virtual object and the second virtual object may take a virtual vehicle to travel to a specific virtual scene in the game task a case that the game preparation stage of the first virtual object and the second virtual object ends. When the virtual vehicle is a virtual car, the foregoing following relationship may be that the second virtual object rides the same virtual car to the same virtual scene as the first virtual object. When the virtual vehicle is a virtual aircraft, the following relationship may be that the second virtual object rides the same virtual aircraft as the first virtual object and travels to the same virtual scene by “parachuting” at the same time point. The foregoing descriptions of the following relationship are merely examples and do not limit a following manner in a specific implementation.

According to the foregoing implementations of this application, when the target scene point is marked in the scene map in the preparation interface of the first virtual object, the corresponding entry prompt information is generated and provided, and invitation information is transmitted to another virtual object in response to the transmitting operation, so that the mark information is transmitted to another virtual object in a form of an invitation, ensuring that another virtual object can receive the mark information of the current player. In addition, a display operation and an invitation operation of the mark information are simplified, a technical problem of low display efficiency of the mark information in the existing game preparation stage is resolved, and a technical effect of improving the display efficiency of the mark information is achieved.

In an implementation, during the operation of displaying the preparation interface before the first virtual object enters the virtual game scene configured for the game task, the method for displaying mark information further includes:
S1: A first policy control corresponding to the first virtual object displayed in the preparation interface is in an unplanned state when a marking operation on the target scene point in the scene map is not received, where the first policy control in the unplanned state is configured to indicate that the task confrontation policy is not determined.
S2: Display, when the marking operation on the target scene point in the scene map is received, a marked target scene point in the scene map, and adjust the first policy control from the unplanned state to a planned state, where the first policy control in the planned state is configured to indicate that the task confrontation policy is determined.

In an embodiment, the foregoing preparation interface may display the scene map and the policy control synchronously, and the policy control is configured to display a planned task confrontation policy.

As shown in FIG. 4, FIG. 4 shows that the first policy control corresponding to the first virtual object displayed in the preparation interface is in the unplanned state when the marking operation on the target scene point in the scene map is not received. That is, the policy control corresponding to the current player in the “Planning” box in FIG. 4 is displayed in a blank state. As shown in FIG. 5, FIG. 5 shows that when the marking operation on the target scene point in the scene map is received, the marked target scene point, namely, the mark point 404, is displayed in the scene map while the first policy control 402 is adjusted from the unplanned state to the planned state. In an embodiment, the foregoing first policy control is a “Planning” box region corresponding to the entry prompt information 405.

In an embodiment, when the target scene point marked in the scene map is changed, the entry prompt information displayed in the first policy control may correspondingly change based on a changed target scene point.

According to the foregoing implementations of this application, the corresponding first policy control may be displayed based on a marking status (which indicates whether the target scene point is marked) in the scene map, and corresponding policy information is displayed in real time through the first policy control, thereby improving display efficiency of the first policy control.

In an implementation, the operation of providing the entry prompt information matching the target scene point includes:
S1: Determine a region type of a scene region in which the entry position corresponding to the target scene point is located.
S2: Provide the entry position, and provide the task confrontation policy matching the region type.

In an embodiment, the correspondence between the foregoing target scene point and a matched task confrontation policy may be determined based on the region type of the scene region. For example, the foregoing region types may be classified based on a number of virtual resources. For example, the region types may be classified into three types of regions: “more resources”, “medium resources”, and “fewer resources”. For a region of the type “more resources”, a corresponding task confrontation policy may be “Develop”, for a region of the type “medium resources”, a corresponding task confrontation policy may be “Battle”, and for a region of the type “fewer resources”, a corresponding task confrontation policy may be “Gather”. The classification of the region types may alternatively be performed based on region terrains. For example, for a terrain suitable for an ambush battle, a corresponding task confrontation policy may be “Develop”. For a terrain suitable for a laneway battle, a corresponding task confrontation policy may be “Battle”. For a region unsuitable for battle, a corresponding task confrontation policy may be “Gather”.

In a specific implementation, the classification of the region types may be performed based on terrain characteristics of the target scene point. For example, in FIG. 5, “Base A” corresponds to a terrain type of a “terrain suitable for an ambush battle”, “City B”, “City G”, and “Port F” correspond to a terrain type of a “terrain suitable for a laneway battle”, and “Hill C”, “Mine E”, and “Farm D” correspond to a terrain type of a “region unsuitable for battle”. In this way, based on the correspondence between the foregoing region type and the task confrontation policy, a correspondence between a specific scenario and the task confrontation policy may be further determined. For example, when the foregoing task confrontation policy includes “Gather”, “Battle”, and “Develop”, the correspondence between the foregoing entry position and the task confrontation policy may be “Base A”—“Develop”; “City B”, “City G”, and “Port F”—“Battle”; and “Hill C”, “Mine E”, and “Farm D”—“Gather”. The foregoing preset correspondence is merely an example, and does not limit a specific correspondence set in a specific implementation.

A manner of dividing different regions in the embodiments of this application is described in below with reference to FIG. 5. In an embodiment, different regions in the map 401 need to be divided in advance, and an “identifier” and a “type” are assigned to each region. Specific operations may include:
S1: Obtain a region through division.
S2: Determine a coordinate range of the region.
S3: Assign an “identifier” and a “type” to the region.
S4: Obtain a mark point of a player, and determine whether coordinates of the mark point are within the coordinate range.

For example, it is assumed that the coordinate range of “City B” in FIG. 5 is that: X: 400 to 800; and Y: 600 to 12000. When it is determined that the mark point of the first virtual object is within the coordinate range of “City B”, the entry prompt information 405 is automatically determined, that is, the corresponding task confrontation policy is determined as “Battle” based on a type and an identifier of “City B”. In this way, the entry prompt information 405 is determined as “City B; Battle”.

According to the foregoing implementation of this application, when the region type of the scene region in which the entry position is located is determined, the corresponding task confrontation policy can be automatically determined, thereby improving confirmation efficiency of the task confrontation policy.

In an implementation, after the operation of providing the task confrontation policy matching the region type, the method for displaying mark information further includes: switching the task confrontation policy in response to a switching operation on the task confrontation policy.

In an embodiment, after the entry position is provided, and the task confrontation policy matching the region type is provided, the task confrontation policy may be switched based on a selection operation of the player. For example, in FIG. 5, the task confrontation policy corresponding to a preset “City B” is “Battle”, and in response to the selection operation of the player, the task confrontation policy may be further switched, for example, from “Battle” to “Develop”.

According to the foregoing implementation of this application, a switching method for a task confrontation policy is provided, to achieve a selection of the task confrontation policy by the player. In this way, a technical effect of flexibly switching the task confrontation policy is achieved.

In an implementation, after the operation of transmitting the first entry invitation information to the second virtual object participating in the game task, the method for displaying mark information further includes:
S1: Control the first virtual object to enter the virtual game scene from the entry position.
S2: Display an entry scene interface corresponding to the entry position when the second virtual object determines to follow the first virtual object based on the first entry invitation information; and display, in the entry scene interface, the first virtual object and the second virtual object following the first virtual object that enter in sequence.
S3: Display the entry scene interface corresponding to the entry position when the second virtual object does not determine, based on the first entry invitation information, to follow the first virtual object; and display, in the entry scene interface, the first virtual object that enters.

In an embodiment, after the operation of transmitting the first entry invitation information to the second virtual object participating in the game task, the invitation control may be controlled to be displayed in a cooling state, that is, a timing state. After the invitation control, for example, an “Initiate parachuting invitation” control in FIG. 5, is triggered, the invitation control may be controlled to be displayed as a “30 s” countdown. In this way, the invitation control may be controlled to enter a 30 s countdown (not shown in FIG. 5), to avoid the first virtual object frequently initiating the following invitation.

In an embodiment, when the second virtual object receives the first invitation information transmitted by the first virtual object, the following relationship between the second virtual object and the first virtual object is determined, and when the first virtual object enters the virtual game scene from the entry position, the second virtual object is controlled to follow the first virtual object into the virtual game scene from the same entry position. When the second virtual object does not determine, based on the first entry invitation information, to follow the first virtual object, it is displayed that the first virtual object enters the virtual game scene from the entry position.

Further, in an embodiment, when a manner of the first virtual object entering an official game task from a preparation stage is riding a virtual aerial vehicle, the foregoing manner of displaying the entry scene interface corresponding to the entry position may be that the first virtual object enters a scene picture by virtual parachuting from the virtual aerial vehicle at a corresponding entering moment. Correspondingly, when the second virtual object is in the following relationship with the first virtual object, the second virtual object is controlled to follow the first virtual object entering the same scene picture by virtual parachuting at the same moment.

According to the foregoing implementation of this application, the second virtual object in the following relationship with the first virtual object can be controlled to follow the first virtual object at the same position and in the same manner into a virtual scene picture. In this way, the virtual object in the following relationship is automatically controlled to enter the same virtual scene, which improves control efficiency for the second virtual object.

In an implementation, during the operation of displaying the preparation interface before the first virtual object enters the virtual game scene configured for the game task, the method for displaying mark information further includes:
S1: Display an invitation prompt pop-up window, where the invitation prompt pop-up window is configured for prompting second entry invitation information transmitted by a third virtual object participating in the game task, the second entry invitation information is configured for inviting the first virtual object to follow the third virtual object into the virtual game scene.
S2: In response to an operation performed on an invitation acceptance control displayed in the invitation prompt pop-up window, close the invitation prompt pop-up window, determine that the first virtual object follows the third virtual object into the virtual game scene, where when the first policy control is in an unplanned state, the first policy control is adjusted from the unplanned state to a planned state.
S3: In response to an operation performed on a refusal control displayed in the invitation prompt pop-up window, close the invitation prompt pop-up window, determine that the first virtual object refuses to follow the third virtual object into the virtual game scene.

In an embodiment, when the first virtual object controlled by the current player is in a non-following status and a non-invitation-initiated status to another player, the following invitation transmitted by a virtual object controlled by another player may be received. A display manner of the foregoing following invitation may be to display a pop-up in the preparation interface, which is configured for prompting to invite the first virtual object to follow the third virtual object into the virtual game scene.

In an embodiment, the foregoing invitation prompt pop-up window may include object identifier information of the third virtual object transmitting an invitation, object serial number information, target scene point information marked by the third virtual object, and task confrontation policy information expected to be adopted by the third virtual object. In this way, the first virtual object may determine whether to accept the following invitation transmitted by the third virtual object based on related information included in the invitation prompt pop-up window.

Further, at least an “Invitation acceptance control” and a “Refusal control” may be configured in the invitation prompt pop-up window to provide a quick way for the first virtual object to return to the third virtual object. Specifically, in response to an operation performed on the “Invitation acceptance control”, it may be determined that the first virtual object accepts the following invitation transmitted by the third virtual object, and the planning state is adjusted in the first policy control corresponding to the first virtual object. In response to an operation performed on the “Refusal control,” it may be determined that the first virtual object refuses the following invitation transmitted by the third virtual object.

The foregoing invitation prompt pop-up window may be displayed in a center of an interface in a suspended manner over another interface element; and may also be displayed in a lower right corner of an interface in a suspended manner over another interface element. A display position of the invitation prompt pop-up window is not limited in this embodiment. In an embodiment, a display manner of the invitation prompt pop-up window may be a progressive display manner, and cancel the display in a fade display manner. The display manner of the invitation prompt pop-up window may also be displayed in a manner of sliding in from a right side of the interface and canceled to be displayed in a manner of sliding out to the right side of the interface. The display manner of the invitation prompt pop-up window is not limited in the embodiments of this application.

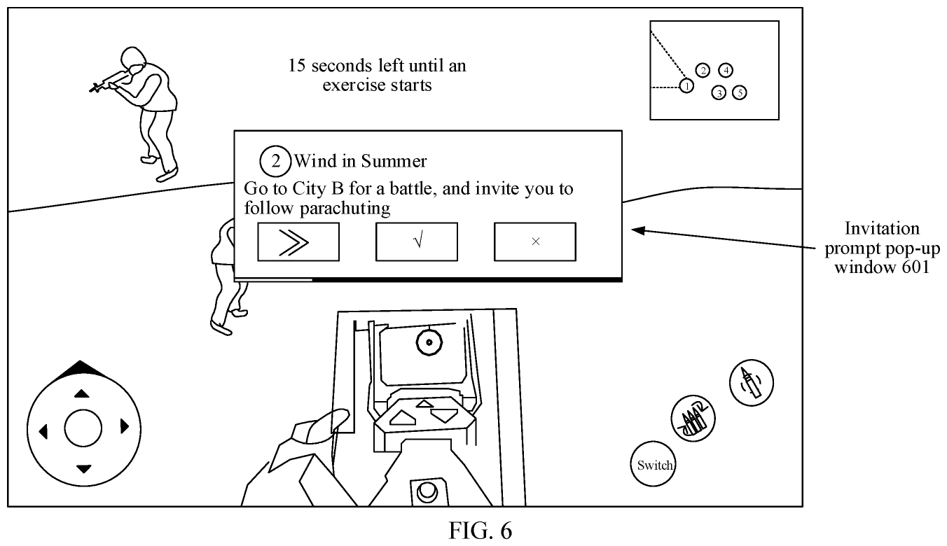

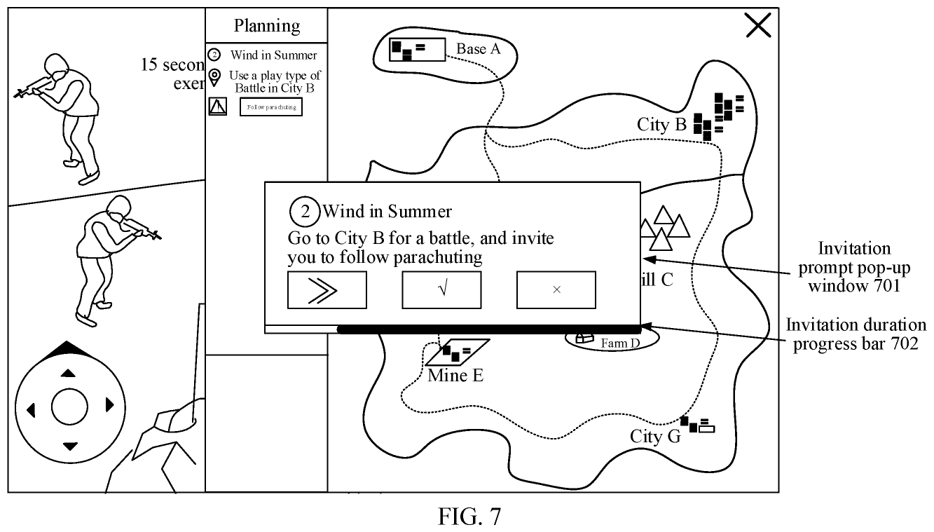

With reference to FIG. 6 and FIG. 7, a specific display manner of the foregoing invitation prompt pop-up window is described below. As shown in FIG. 6, when a current interface in which the first virtual object is located is displayed as a virtual scene picture corresponding to the preparation stage, the invitation prompt pop-up window is displayed in the center of the interface, that is, the invitation prompt pop-up window 601 displayed in the interface of FIG. 6. The invitation prompt pop-up window 601 includes at least the object identifier information “Wind in summer” of the third virtual object, the object serial number information “2”, the target scene point “City B” marked by the third virtual object, or the selected task confrontation policy information “Battle”. Correspondingly, the invitation prompt pop-up window 601 further includes an invitation acceptance control “V” located below the middle of the pop-up window, and a refusal control “x” located below a right side of the pop-up window. In an embodiment, a control located below a left side of the pop-up window may be a detail display control, and in response to a trigger operation of the detail display control, the mark point of the third virtual object and related invitation information may be displayed in the large map.

As shown in FIG. 7, when the current interface in which the first virtual object is located is displayed as the large map in the preparation stage, the invitation prompt pop-up window may be displayed on the large map in a suspended manner, that is, the invitation prompt pop-up window 701 displayed in FIG. 7.

In FIG. 7, in response to a trigger operation of the “V” control in the invitation prompt pop-up window 701, it is determined that the first virtual object becomes a follower of the third virtual object, and a corresponding planned state is displayed in the first policy control below a planning box on the right side of the large map (not shown in FIG. 7).

In an embodiment, while the invitation prompt pop-up window is displayed in FIG. 6 and FIG. 7, prompt content, for example, “(2. Wind in summer: Go to City B for a battle, and invite you to follow parachuting”, corresponding to the invitation prompt pop-up window may be further displayed in a session region of a main page.

In the foregoing implementation of this application, the following invitation transmitted by another virtual object is displayed in the interface through the pop-up window, and the feedback control is configured to facilitate the first virtual object to quickly returns the following information to another virtual object transmitting the following invitation, so that the player can quickly confirm whether another player receives the mark information, and whether to accept the following invitation. In this way, the display efficiency of the mark information is improved.

In an implementation, after the displaying an invitation prompt pop-up window, the method for displaying mark information further includes:
S1: Prompt a display duration of the invitation prompt pop-up window.
S2: Close the invitation prompt pop-up window when the display duration of the invitation prompt pop-up window reaches a target threshold, but no operation performed on the invitation acceptance control or the refusal control displayed in the invitation prompt pop-up window is received.

In an embodiment, since the invitation prompt pop-up window may be displayed in the preparation interface, the display duration of the invitation prompt pop-up window may be further set and prompted in the invitation prompt pop-up window. For example, the prompt manner of the foregoing display duration may be in the form of a countdown, for example, the prompt information is determined based on the display duration as follows: “Invitation countdown: 3 s”, “Invitation countdown: 2 s”, “Invitation countdown: 1 s”, and the like. In another implementation, the prompt manner of the display duration may be graphically prompted, for example, prompted in the form of a progress bar, or in the form of a pie chart. The prompt manner of the display duration is not limited in this embodiment.

As shown in FIG. 7, the display duration may be prompted in the form of an invitation duration progress bar 702 below the invitation prompt pop-up window 701, and the display of the invitation prompt pop-up window 701 may be cancelled when the display duration of the invitation prompt pop-up window reaches the target threshold. In an embodiment, when the display duration of the invitation prompt pop-up window reaches the target threshold, but an operation performed on the invitation acceptance control or the refusal control displayed in the invitation prompt pop-up window is not received, the first virtual object may be determined to reject the following invitation transmitted by the third virtual object.

In the foregoing implementation of this application, the invitation prompt pop-up window is displayed for limited time, which avoids that the pop-up window is always displayed in the interface, and improves the display efficiency of the interface. In addition, a prompt effect of the invitation information can be promoted by prompting through the pop-up window.

In an implementation, during the operation of displaying the preparation interface before the first virtual object enters the virtual game scene configured for the game task, the method for displaying mark information further includes:
S1: Determine that a fourth virtual object belonging to the same camp as the first virtual object has not determined the task confrontation policy when a second policy control displayed in the preparation interface is in an unplanned state.
S2: Determine that the fourth virtual object belonging to the same camps as the first virtual object has determined the task confrontation policy when the second policy control displayed in the preparation interface in a planned state.

In an embodiment, when a virtual object in the same camp as the first virtual object has marked the target scene point on the map and transmits the following invitation, the corresponding task confrontation policy information may be displayed in the second policy control. When a virtual object in the same camp as the first virtual object does not mark the target scene point on the map and does not transmit the following invitation, the second policy control may be displayed in a blank state.

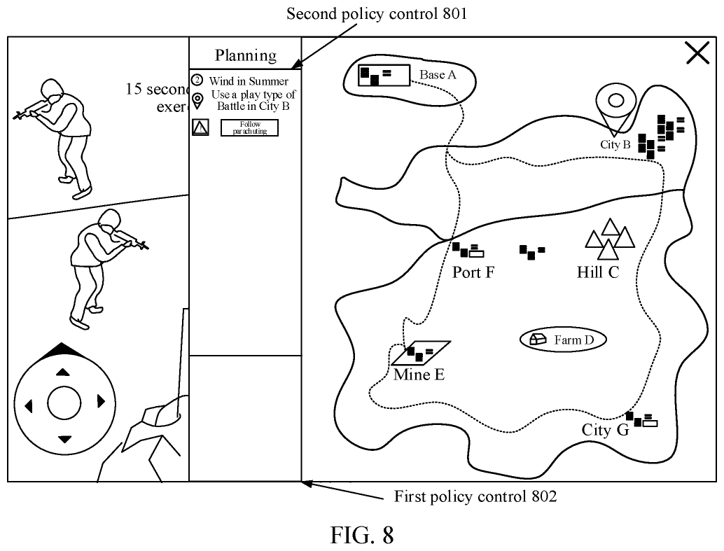

With reference to FIG. 4 and FIG. 8, a specific implementation of the foregoing method is described below. As shown in FIG. 4, when a virtual object in the same camp as the first virtual object does not mark the target scene point on the map and does not transmit the following invitation, the second policy control 403 on a left side of the game map 401 is displayed in a blank state. As shown in FIG. 8, assuming that the third virtual object “Wind in Summer” in the same camp as the first virtual object marks the target scene point “City B” in the map and selects the “Battle” policy, related policy prompt information may be displayed in the second policy control 801 on the left side of the game map. In an embodiment, since the first virtual object does not mark the target scene point in the map, and does not transmit the following invitation to another virtual object, policy information related to the first virtual object is not displayed in the first policy control 802.

According to the foregoing implementation of this application, policy information related to the virtual object in the same camps as the first virtual object is displayed in the second policy control. In this way, avoiding a technical problem that the virtual objects in the same camps are unclear whether another virtual object learns about the mark information and the battle policy, improving the display efficiency of the mark information.

In an implementation, after the determining that a fourth virtual object belonging to the same camps as the first virtual object has determined the task confrontation policy, the method for displaying mark information further includes:
S1: Display, in response to an operation performed on the second policy control in the planned state, a determined reference entry position of the fourth virtual object and a reference task confrontation policy matching the reference entry position, the reference entry position being an entry position of the fourth virtual object entering into the virtual game scene, and the reference task confrontation policy being a task confrontation policy matching the entry position of the fourth virtual object.
S2: Adjust, in response to an operation performed on a feedback control corresponding to the reference task confrontation policy, the feedback control to a timing state, and prompt feedback information of the first virtual object based on a marking status of the scene map, the marking status indicating whether the first virtual object marks the target scene point.
S3: Adjust, in response to an operation performed on a following control corresponding to the reference task confrontation policy, the following control to the timing state. When a follow authorization of the fourth virtual object is received, it is determined that the first virtual object follows the fourth virtual object into the virtual game scene from the reference entry position.

In an embodiment, in addition to displaying policy information related to the fourth virtual object in the same camp as the first virtual object in the second policy control, the feedback control and the following control may be further configured. The feedback control is configured to prompt feedback information of the first virtual object based on the marking status of the scene map, and the feedback information is typically negative feedback information, such as reject to follow to a relevant place or reject to use a relevant task confrontation policy. The following control is configured to transmit a following request to the fourth virtual object and determine that the first virtual object becomes a follower of the fourth virtual object when the fourth virtual object accepts the following request.

Further, when responding to a trigger operation on the foregoing feedback control or the following control by the first virtual object, a corresponding control may be adjusted to the timing state, so as to avoid the first virtual object frequently transmitting feedback information or frequently changing the following status.

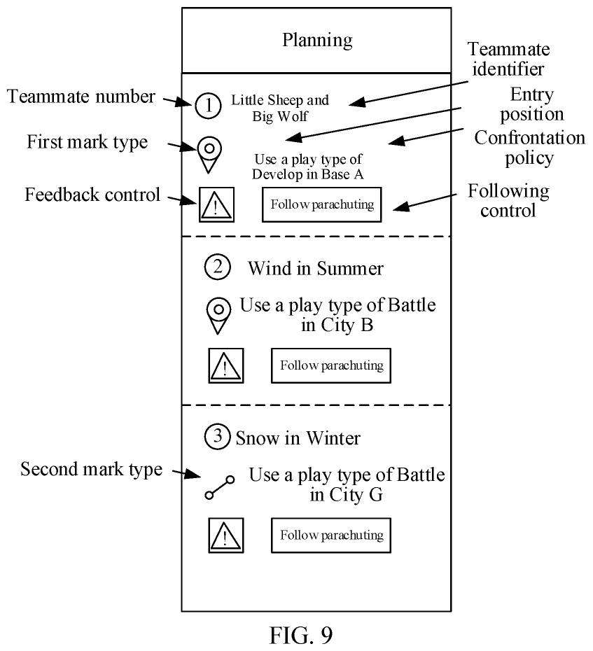

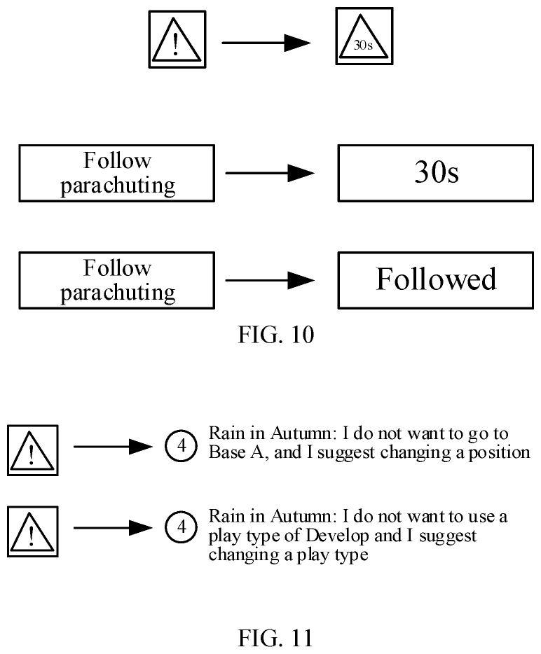

With reference to FIG. 9 and FIG. 10, a specific display manner of the foregoing second policy control is described below. FIG. 9 may be a detailed display manner of the second policy control shown in FIG. 8. In the second policy control in FIG. 9, a total of three pieces of policy information of virtual objects in the same camp as the first virtual object are displayed, namely, policy information for a virtual object with teammate number “1” and teammate identifier “Little Sheep and Big Wolf”, policy information for a virtual object with teammate number “2” and teammate identifier “Wind in Summer”, and policy information for a virtual object with teammate number “3” and teammate identifier “Snow in Winter”. In an embodiment, the foregoing three pieces of policy information may be displayed in a time order of generation, for example, the policy information for the virtual object with teammate number “1” and teammate identifier “Little Sheep and Big Wolf” may be the latest generated policy information, and the policy information for the virtual object with teammate number “3” and teammate identifier “Snow in Winter” may be the first generated policy information.

Further, in each piece of policy information, at least the following types of information elements are included. As shown in FIG. 9, each piece of policy information includes at least a “teammate number”, a “teammate identifier”, a “mark type”, an “entry position”, a “confrontation policy”, a “feedback control”, or a “following control”. The “teammate number” is configured for indicating a unique number of the virtual object in a current camp, and the “teammate identifier” is configured for indicating a game ID of the virtual object in the game task.

The foregoing “Mark type” may specifically include a “First mark type” and a “Second mark type”. The “First mark type” corresponds to a single point mark manner in which the player clicks a large map to mark points, representing that a position on the map corresponding to the mark point has an icon with a player number color, and a linear distance of the player from the position. Another player may also see the mark point on the map. The “Second mark type” corresponds to a line mark, and the player can switch from the “single point mark” to the “Line mark” by clicking a lower left button on the large map. After switching, the player clicks a point on the large map to create a starting point of a broken line at the point, clicks again to create a turning point of the broken line, and repeats this operation until a fifth click. When a broken line is created and no further click is performed. As shown in FIG. 9, the mark manner configured for the “Little Sheep and Big Wolf” is the “single point mark”, and the mark manner configured for “Snow in Winter” is the “linemark”.

Further, “Entry position” information and “Confrontation policy” information included in the foregoing policy information are information selected by the virtual object of the same camp during marking points. The “Feedback control” shown in FIG. 9 is configured to prompt the feedback information of the first virtual object based on the marking status of the scene map, and the marking status indicates whether the first virtual object marks the target scene point. The feedback information is typically negative feedback information, such as reject to follow to a relevant place or reject to use a relevant task confrontation policy. The “Following control” in FIG. 9 is configured to transmit the following request to the fourth virtual object and determine that the first virtual object becomes the follower of the fourth virtual object when the fourth virtual object accepts the following request.

As shown in FIG. 10, FIG. 10 shows a display variation method of a “Feedback control” and a “Following control”. As in FIG. 10, when the “Feedback control” is clicked, a countdown of 30 s starts to be displayed in the “Feedback control”. When the “Following control” is clicked, a countdown of 30 s starts to be displayed in the “Following control”. In an embodiment, when the “Following control” is clicked and a corresponding virtual object accepts the following request, the “Following control” may be displayed as a “Followed” control style.

In the foregoing implementation of this application, following status information can be fed back quickly to the corresponding virtual object through the trigger operation received in the second policy control. In this way, a fast feedback method is provided and the policy information of the teammate is displayed, which improves the display efficiency of the mark information.

In an implementation, the prompting the feedback information of the first virtual object based on the marking status of the scene map includes:
S1: When the marking status of the scene map indicates that the target scene point is not marked, prompt the feedback information of the first virtual object to reject to follow the fourth virtual object into the virtual game scene from the reference entry position.
S2: When the marking status of the scene map indicates that the target scene point is marked, but a marked target scene point does not match a reference scene point corresponding to the reference entry position, prompt the feedback information of the first virtual object to reject to follow the fourth virtual object into the virtual game scene from the reference entry position.
S3: When the marking status of the scene map indicates that the target scene point is marked, and the marked target scene point matches the reference scene point corresponding to the reference entry position, prompt the feedback information of the first virtual object that the reference task confrontation policy is rejected.

In an embodiment, in response to the trigger operation on the feedback control, corresponding feedback information may be determined based on the mark information of the first virtual object in the scene map. For example, when the first virtual object does not mark points in the scene map, feedback information rejecting to go to the target scene point corresponding to a current feedback control may be transmitted. When the first virtual object marks points in the scene map, the marked target scene point and the reference scene point can be compared for consistency. When the two are consistent, feedback information rejecting to use the confrontation policy corresponding to the current feedback control is transmitted, or when the two are inconsistent, feedback information rejecting to go to the target scene point corresponding to the current feedback control is transmitted.

With reference to FIG. 9 and FIG. 11, the foregoing implementation is described below. As shown in FIG. 9, in response to the trigger operation on the feedback control of the policy information “A play type of Develop is used at Base A” of the “Little Sheep and Big Wolf”, the mark information of the first virtual object in the scene map may be detected. When it is determined that the first virtual object (assumed to be “Rain in Autumn”) does not mark points in the scene map, feedback information “4. Rain in Autumn: I do not want to go to the Base A, and I suggest changing a position” may be transmitted to the “Little Sheep and Big Wolf”. When it is determined that the first virtual object (assumed to be “Rain in Autumn”) marks points in the scene map, it is possible to further compare whether the marked target scene point is consistent with the “Base A”. If the target scene point is inconsistent with the “Base A”, feedback information “4. Rain in Autumn: I do not want to go to the Base A, and I suggest changing a position” may be transmitted to the “Little Sheep and Big Wolf”. If the target scene point is in consistent with the “Base A”, feedback information “4. Rain in Autumn: I do not want to use a play type of Develop and I suggest changing a play type” may be transmitted to the “Little Sheep and Big Wolf”.

Through the foregoing implementation of this application, quick feedback can be performed based on the marking status of the first virtual object, which improves display and feedback efficiency of the mark information.

A complete implementation process of the embodiments of this application is described below. First, a “Follower” and a “Parachuting captain” in this embodiment are described. Follower: The current player may initiate the following request to any player in a birth island until the current player leaves an aircraft. Once an application is successful, a parachuting trajectory of the parachuting captain is completely synchronized until landing on the ground. For example, a player A initiates the following request to a player B, and after the player B agrees, the player A becomes a follower to follow the player B. Parachuting captain: The current player may initiate the following invitation to one or more players in the birth island until the current player leaves the aircraft. Once an invitation is successful, a player agreeing to the invitation becomes a follower of the current player, and the current player also becomes the parachuting captain. For example: The player A initiates the following invitation to the player B, a player C, and a player D, the player B and the player C agree, and player D refuses. In this case, the player A is the parachuting captain, and the player B and the player C are followers of the player A. In an embodiment, it is also possible to become the parachuting captain by agreeing to other people's following requests. For example: The player A initiates the following request to the player B, and after the player B agrees, the player B becomes the parachuting captain, and the player A is the follower of the player B.

In an embodiment, to improve a process of marking points to parachuting and complete the most accurate operation with the least number of steps, the following processing may be performed. One side pull-down box is added to the display interface of the large map. The side pull-down box may include two pieces of content: teammate parachuting planning (four states) and my parachuting planning (three states). One TIPS and two GUIs are added on the main interface: including automatic text transmission and map position switching. Therefore, there are a total of five GUI effects to complete the implementations of functions and information transmission. Specific logic is shown in the following embodiments.

As shown in FIG. 4, when the player opens the display interface of the large map from the birth island until the player leaves the aircraft, a side pull-down box of “Parachuting planning” is displayed on the left side. The “parachuting planning” may include two modules: “Teammate parachuting planning” and “My parachuting planning”, where the “Teammate parachuting planning” corresponds to the second policy control 403 in FIG. 4, and the “My parachuting planning” corresponds to the first policy control 402 in FIG. 4.

Further, when no teammate becomes the “Parachuting captain” (that is, the reference scene point is not marked, and no parachuting invitation is initiated), the second policy control 403 is displayed in a blank state. As shown in FIG. 8, when the teammate becomes the “Parachuting captain”, related information of the teammate is displayed, including: a number, a name, a mark type, a position of a mark point, a specific play type, a “Feedback” button, and a “Follow parachuting” button. If the current player clicks the “Feedback” button, the button enters a cold down (CD) state and a phrase is automatically transmitted for feedback. If the “Follow parachuting” button is clicked, the button also enters the CD state. In this case, the current player requests to join a parachuting team of the parachuting captain. If the parachuting captain agrees to the request, the current player and all other followers enter a team of the parachuting captain. As shown in FIG. 9, when a plurality of players becomes parachuting captains, the plurality of parachuting captains may be arranged from top to bottom according to a time sequence.

When the current player does not mark points, “My parachuting planning” (that is, the first policy control 402 in FIG. 4) is displayed in a blank state. As shown in FIG. 5, when the current player clicks the scene map to mark points, the following related information is displayed in the first policy control 402: a mark type, a position of a mark point, “Play type selection tag” and “Parachuting invitation” buttons. The “Play type selection tag” may be switched by clicking, for example, switched from “Gather” to “Battle”. The default “Play type selection tag” is “Gather”. After the “Follow parachuting” button is clicked, the button enters a CD state and a text is automatically transmitted on the main interface: “I initiated which play type at which position”, and all players who are neither parachuting captains nor followers receive the parachuting invitation on the main interface.

As shown in FIG. 6 and FIG. 7, when the current player is neither the parachuting captain nor the follower, and another player initiates the parachuting invitation, the TIPS is popped up in the main interface, and the scene map is switched to a position marked by the another player. The TIPS includes: a number, a name, a position, and a play type text, a “View” button, a “Follow parachuting” button, and a countdown prompt. If the current player clicks the “View” button, the TIPS is disappeared and the display interface of the large map is opened. If the “Follow parachuting” button is clicked, the TIPS is also disappeared, and the current player becomes the follower of another player; and the TIPS is also disappeared if the current player does not operate after the 3 second countdown ends.

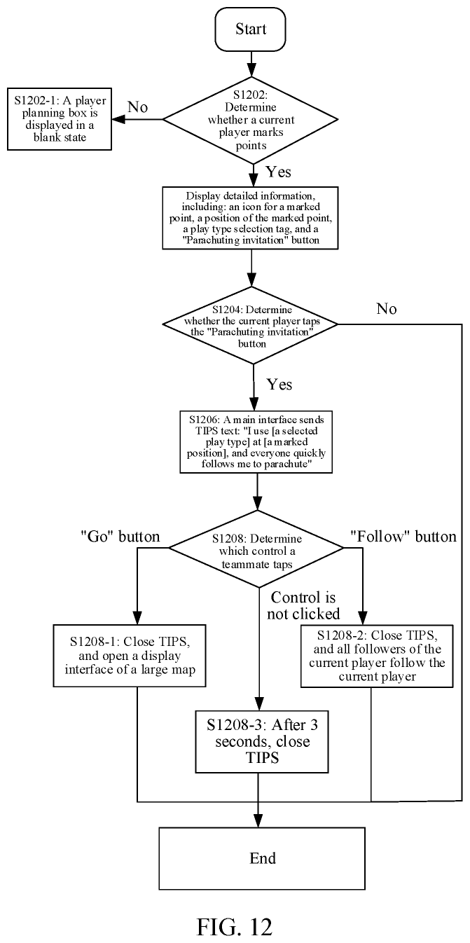

With reference to FIG. 12, a determining procedure of the foregoing implementation of this application is described below.
Operation S1202: Determine whether a current player marks points.
Operation S1202-1 is performed when the current player does not mark points, and a player planning box is displayed in a blank state. Operation S1202-2 is performed when the current player marks point. Displaying detailed information includes: an icon for marking points, a position for marking points, a play type selection tag, and a “Parachuting invitation” button.

In an embodiment, the region type of the region to which the mark point belongs may be determined based on a “Region division map”. If the mark point belongs to an urban region, the play type selection tag is switched to “Battle”, if the mark point belongs to a jungle region, the play type selection tag is switched to “Develop”, and if the mark point belongs to another region, the play type selection tag is switched to “Gather”.

Next, as shown in FIG. 5, operation S1204 is performed to determine whether the current player clicks the “Parachuting invitation” button.

When the current player clicks the “Parachuting invitation” button, operation S1206 is performed, and the main interface transmits TIPS text: “I use [a selected play type] at [a marked position], and everyone quickly follows me to parachute”. In an embodiment, all other players who are neither the captain nor the follower receive the TIPS, and the minimap is switched to a corresponding point position.

Next, operation S1208 is performed to determine which control the teammate clicks.

When the teammate clicks a “Go” button, operation S1208-1 is performed, the TIPS are closed, and the display interface of the large map is opened. When the teammate clicks the “Follow” button, operation S1208-2 is performed, the TIPS are closed, and all followers of the current player follow the current player. When the teammate does not click any control, operation S1208-3 is performed. After 3 seconds, the TIPS are closed. A closing manner may be to hide the TIPS and end the procedure.

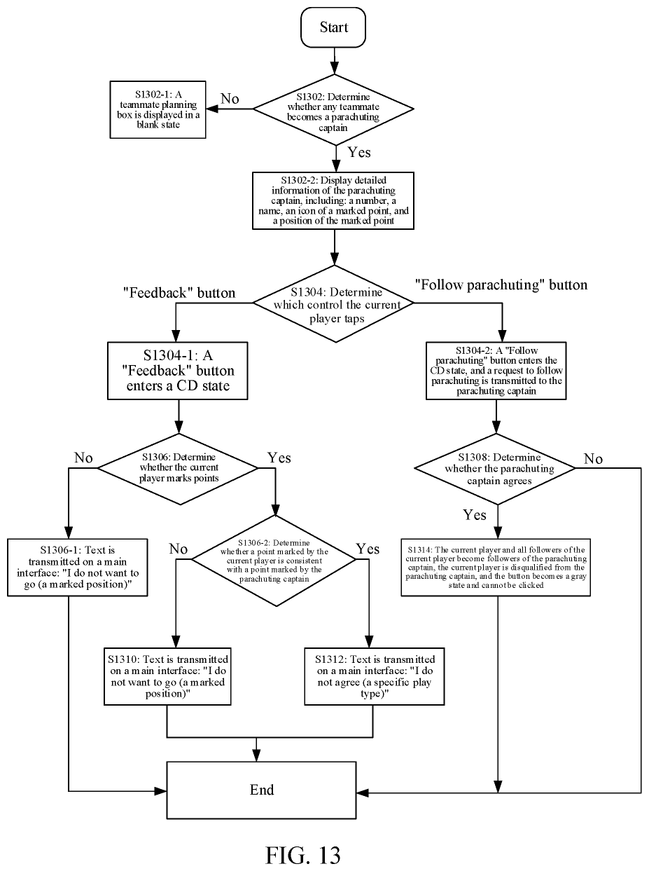

With reference to FIG. 13, another determining procedure of the foregoing implementation of this application is described below.

Operation S1302 is first performed to determine whether any teammate becomes a parachuting captain. In an embodiment, a manner of becoming the parachuting captain may be marking on the scene map and transmitting a following invitation to another teammate.

When no teammate becomes the parachuting captain, operation S1302-1 is performed, and the teammate planning box is displayed in a blank state. When the teammate becomes the parachuting captain, operation S1302-2 is performed, and detailed information of the parachuting captain is displayed, including: a number, a name, an icon for marking points, and a position for marking points.

Next, operation S1304 is performed to determine which control the current player clicks.

When the current player clicks the “Feedback” button, operation S1304-1 is performed, and the “Feedback” button enters the CD state. When the current player clicks the “Follow parachuting” button, operation S1304-2 is performed. The “Follow parachuting” button enters the CD state, and requests to follow parachuting from the parachuting captain.

When the current player clicks the “Feedback” button, operation S1306 is performed to determine whether the current player marks points.

When the current player does not mark points, operation S1306-1 is performed, and a text is transmitted on the main interface: “I do not want to go (a marked position)”. When the current player mark points, operation S1306-2 is performed, to determine whether a point marked by the current player is consistent with a point marked by the parachuting captain. In a case of inconsistency, operation S1310 is performed, and a text is transmitted on the main interface: “I do not want to go (a marked position)”. In a case of consistency, operation S1312 is performed, and a text is transmitted on the main interface: “I do not agree (a specific play type)”.

When the current player clicks the “Follow parachuting” button, and after operation S1304-2 is performed, operation S1308 is performed, to determine whether the parachuting captain agrees. When the parachuting captain agrees, operation S1314 is continuously performed. When the current player and all of the followers of the current player become followers of the parachuting captain, and the current player disqualifies the parachuting captain, and the button becomes a gray state and cannot be clicked.

Through the foregoing implementation of this application, a module such as “Parachuting planning” is added to the display interface of the large map, to open a break point between marking points and parachuting. The following four functions, namely intelligent recognition of a mark point, intelligent switching tag, one-key text transmitting, and parachuting invitation are added, a control used by the player in a process of marking points on parachuting is more convenient and accurate, and the player obtains more information and functions while reducing operations, thereby ensuring efficient communication efficiency for the player to enter the game scene. In this way, a fullest function is provided through a simple interaction operation, and efficiency of the follow parachuting and a quality of team cooperation are effectively improved.

For ease of description, the foregoing method embodiments are described as a series of action combinations. However, a person skilled in the art is to learn that the embodiments of this application are not limited to the described action orders because some operations may be performed in another order or performed at the same time according to the embodiments of this application. In addition, a person skilled in the art is also to learn that the related actions and modules in the embodiments described in the specification are not necessary for this application.

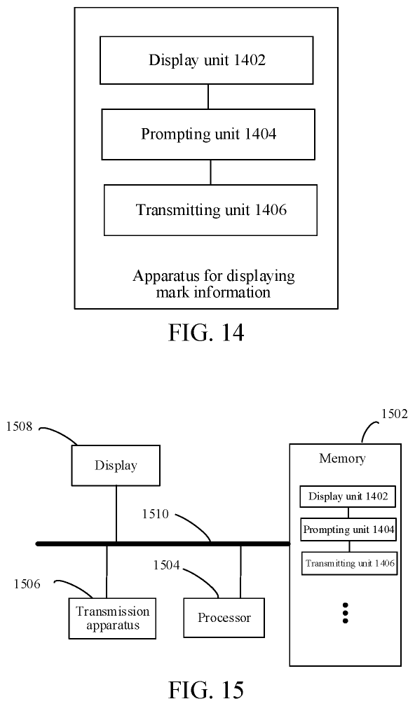

According to an embodiment of this application, a display apparatus configured to perform the foregoing method for displaying mark information is further provided. As shown in FIG. 14, the apparatus includes:
a display unit 1402, configured to: display, after determining that a first virtual object participates in a game task, a preparation interface before the first virtual object enters a virtual game scene configured for the game task, where a scene map corresponding to the virtual game scene is displayed in the preparation interface;
a prompting unit 1404, configured to prompt, when a target scene point in the scene map is marked, entry prompt information matching the target scene point, where the entry prompt information is configured for prompting an entry position when the first virtual object enters the virtual game scene, and a task confrontation policy matching the entry position; and
a transmitting unit 1406, configured to transmit first entry invitation information to a second virtual object participating in the game task in response to an operation performed on an invitation control matching the target scene point, where the first entry invitation information is configured for inviting the second virtual object to follow the first virtual object to into the virtual game scene.

In an embodiment, for implementation of functions of the foregoing units or modules, reference may be made to the foregoing method embodiments. The term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more units or modules. Moreover, each unit or module can be part of an overall unit that includes the functionalities of the unit or module. Details are not described herein again.

According to an embodiment of this application, an electronic device configured to implement the foregoing method for displaying mark information is further provided. The electronic device may be the terminal device or the server shown in FIG. 15. In this embodiment, an example in which the electronic device is the terminal device is used for description. As shown in FIG. 15, the electronic device includes a memory 1502 and a processor 1504. The memory 1502 has a computer program stored therein. The processor 1504 is configured to perform the operations in any one of the foregoing method embodiments by executing the computer program.

In an embodiment, the foregoing electronic device may be located in at least one of a plurality of network devices in a computer network.

A person of ordinary skill in the art may understand that the structure shown in FIG. 15 is only for exemplary embodiment, and the electronic device may also be a terminal device such as an in-vehicle terminal, a smart phone (for example, an Android phone and an iOS phone), a tablet computer, a palmtop computer, and a mobile internet device (MID), and a PAD. FIG. 15 does not limit the structure of the foregoing electronic device. For example, the electronic device may further include more or fewer components (for example, a network interface) than those shown in FIG. 15, or have a configuration different from that shown in FIG. 15.

In an embodiment, the memory 1502 may be configured to store a software program and a module, for example, a program instruction and/or a module corresponding to the method and apparatus for displaying mark information in the embodiments of this application, and the processor 1504 runs the software program and the module stored in the memory 1502, to perform various function applications and data processing, that is, implement the foregoing method for displaying mark information. The memory 1502 may include a high-speed random access memory, and may further include a non-volatile memory such as one or more magnetic storage apparatuses, a flash memory, or another non-volatile solid-state memory. In some embodiments, the memory 1502 may further include memories remotely disposed relative to the processor 1504, and these remote memories may be connected to the terminal device through a network. The foregoing examples of the network include, but are not limited to, the Internet, an intranet, a local area network, a mobile communication network, and a combination thereof. The memory 1502 may be specifically configured to, but is not limited to, store file information such as target logical files. In an example, as shown in FIG. 15, the foregoing memory 1502 may include, but is not limited to, a display unit 1402, a prompting unit 1404, and a transmitting unit 1406 in the foregoing apparatus for displaying mark information. In addition, the memory 1502 may further include, but is not limited to, other modules and units in the foregoing apparatus for displaying mark information. Details are not described in this example again.

In an embodiment, the foregoing transmission apparatus 1506 is configured to receive or transmit data through a network. Specifically, the foregoing network may include a wired network and a wireless network. In an example, the transmission apparatus 1506 includes a network interface controller (NIC). The NIC may be connected to another network device and a router by using a network cable, to communicate with the Internet or a local area network. In an embodiment, the transmission apparatus 1506 is a radio frequency (RF) module, and is configured to communicate with the Internet in a wireless manner.

In addition, the foregoing electronic device may further include: a display 1508, configured to display file information such as the foregoing target logical files; and a connection bus 1510, configured to connect various module components in the electronic device.

In some other embodiments, the foregoing terminal device or server may be a node in a distributed system. The distributed system may be a blockchain system. The blockchain system may be a distributed system formed by a plurality of nodes connected in the form of network communication. A peer to peer (P2P) network may be formed between the nodes. A computing device in any form, for example, an electronic device such as a server or a terminal device, may become a node in the blockchain system by joining the P2P network.

According to an embodiment of this application, a computer program product is provided. The computer program product includes a computer program/instructions, and the computer program/instructions includes program code configured for performing the method shown in the flowchart. In such an embodiment, the computer program may be downloaded and installed from a network through a communication part, and/or installed from a removable medium. When the computer program is executed by a central processing unit, various functions provided in the embodiments of this application are executed.

The sequence numbers of the foregoing embodiments of this application are merely for description purpose, and do not indicate the preference of the embodiments.

According to an embodiment of this application, a non-transitory computer-readable storage medium is provided. The computer-readable storage medium is configured to store computer instructions. A processor of a computer device reads the computer instructions from the computer-readable storage medium, and executes the computer instructions, to cause the computer device to perform the foregoing method for displaying mark information according to the foregoing embodiments.

In an embodiment, a person of ordinary skill in the art may understand that all or some of the operations of the various methods in the foregoing embodiments may be implemented by a computer program instructing relevant hardware of the terminal device. The computer program may be stored in a computer-readable storage medium. The storage medium may include: a flash drive, a read-only memory (ROM), a random access memory (RAM), a magnetic disk, an optical disc, or the like.

When the integrated unit in the foregoing embodiments is implemented in the form of a software function unit and sold or used as an independent product, the integrated unit may be stored in the foregoing computer-readable storage medium. Based on such an understanding, the technical solutions of this application essentially, or a part contributing to the related art, or all or a part of the technical solution may be implemented in a form of a software product. The computer software product is stored in a storage medium and includes several instructions for instructing one or more computer devices (which may be a PC, a server, a network device, or the like) to perform all or some of operations of the foregoing methods in the embodiments of this application.

In the foregoing embodiments of this application, the descriptions of the embodiments have respective focuses. For a part that is not described in detail in an embodiment, reference may be made to related descriptions in other embodiments.

In the several embodiments provided in this application, the disclosed client may be implemented in other manners. The described apparatus embodiment is merely exemplary. For example, the unit division is merely logical function division and may be other division in actual implementation. For example, multiple units or components may be combined or integrated into another system, or some features may be ignored or not performed. In addition, the displayed or discussed mutual couplings or direct couplings or communication connections may be implemented through some interfaces. The indirect couplings or communication connections between the units or modules may be implemented in electronic or another form.

The foregoing units described as separate parts may or may not be physically separate, and parts displayed as units may or may not be physical units, in other words, may be located in one device, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit. The foregoing integrated unit may be implemented in a form of hardware, or may be implemented in a form of a software functional unit.

The foregoing descriptions are merely some implementations of this application, and a person of ordinary skill in the art may make various improvements and modifications without departing from the spirit of this application. All such improvements and refinements shall fall within the protection scope of this application.

What is claimed is:

1. A method for displaying mark information performed by a computer device, the method comprising:
determining that a first virtual object controlled by a user of the computer device participates in a game task;
displaying a preparation interface before the first virtual object enters a virtual game scene configured for the game task, the preparation interface including a scene map corresponding to the virtual game scene;
after a target scene point in the scene map is marked, displaying entry prompt information matching the target scene point in the preparation interface, the entry prompt information providing an entry position for the first virtual object to enter the virtual game scene and a task confrontation policy matching the entry position; and
in response to an operation performed on an invitation control matching the target scene point, transmitting first entry invitation information to a second virtual object participating in the game task, the first entry invitation information including the target scene point for the second virtual object to follow the first virtual object in the game task.

2. The method according to claim 1, wherein the displaying entry prompt information matching the target scene point comprises:
determining a region type of a scene region in which the entry position corresponding to the target scene point is located; and
displaying the entry position and the task confrontation policy matching the region type in the preparation interface.

3. The method according to claim 2, wherein the method further comprises:
updating the task confrontation policy in response to a switching operation on the task confrontation policy.

4. The method according to claim 1, wherein after the transmitting first entry invitation information to a second virtual object participating in the game task, the method further comprises:
controlling the first virtual object to enter the virtual game scene at the entry position;
after the second virtual object determines to follow the first virtual object based on the first entry invitation information, displaying an entry scene interface corresponding to the entry position, the entry scene interface including the first virtual object and the second virtual object following the first virtual object that enter in sequence.

5. The method according to claim 1, wherein the displaying the preparation interface further comprises:
displaying an invitation prompt pop-up window, the invitation prompt pop-up window including second entry invitation information transmitted by a third virtual object participating in the game task, the second entry invitation information inviting the first virtual object to follow the third virtual object into the virtual game scene;
in response to an operation on accepting the invitation prompt pop-up window, closing the invitation prompt pop-up window, and determining that the first virtual object follows the third virtual object into the virtual game scene.

6. The method according to claim 5, wherein the method further comprises:
changing a first policy control corresponding to the first virtual object in the preparation interface from an unplanned state to a planned state after the operation on accepting the invitation prompt pop-up window.

7. The method according to claim 1, wherein the displaying the preparation interface further comprises:
in response to an operation performed on a second policy control corresponding to the first virtual object in the preparation interface, determining a reference entry position of the fourth virtual object and a reference task confrontation policy matching the reference entry position; and
determining that the first virtual object follows the fourth virtual object into the virtual game scene from the reference entry position in response to a follow authorization of the fourth virtual object by the user of the computer device.

8. The method according to claim 7, wherein the method further comprises:
provided feedback information to the fourth virtual object that the first virtual object refuses to follow the fourth virtual object into the virtual game scene from the reference entry position when at least one of the following conditions is met:
when the target scene point is not marked in the scene map; and
when the target scene point is marked in the scene map, but a marked target scene point does not match a reference scene point corresponding to the reference entry position.

9. A computer device, comprising a memory and a processor, the memory having a computer program stored therein, the computer program, when executed by the processor, causing the computer device to perform a method for displaying mark information including:
determining that a first virtual object controlled by a user of the computer device participates in a game task;
displaying a preparation interface before the first virtual object enters a virtual game scene configured for the game task, the preparation interface including a scene map corresponding to the virtual game scene;
after a target scene point in the scene map is marked, displaying entry prompt information matching the target scene point in the preparation interface, the entry prompt information providing an entry position for the first virtual object to enter the virtual game scene and a task confrontation policy matching the entry position; and
in response to an operation performed on an invitation control matching the target scene point, transmitting first entry invitation information to a second virtual object participating in the game task, the first entry invitation information including the target scene point for the second virtual object to follow the first virtual object in the game task.

10. The computer device according to claim 9, wherein the displaying entry prompt information matching the target scene point comprises:
determining a region type of a scene region in which the entry position corresponding to the target scene point is located; and
displaying the entry position and the task confrontation policy matching the region type in the preparation interface.

11. The computer device according to claim 10, wherein the method further comprises:
updating the task confrontation policy in response to a switching operation on the task confrontation policy.

12. The computer device according to claim 9, wherein after the transmitting first entry invitation information to a second virtual object participating in the game task, the method further comprises:
controlling the first virtual object to enter the virtual game scene at the entry position;
after the second virtual object determines to follow the first virtual object based on the first entry invitation information, displaying an entry scene interface corresponding to the entry position, the entry scene interface including the first virtual object and the second virtual object following the first virtual object that enter in sequence.

13. The computer device according to claim 9, wherein the displaying the preparation interface further comprises:
displaying an invitation prompt pop-up window, the invitation prompt pop-up window including second entry invitation information transmitted by a third virtual object participating in the game task, the second entry invitation information inviting the first virtual object to follow the third virtual object into the virtual game scene;
in response to an operation on accepting the invitation prompt pop-up window, closing the invitation prompt pop-up window, and determining that the first virtual object follows the third virtual object into the virtual game scene.

14. The computer device according to claim 13, wherein the method further comprises:
changing a first policy control corresponding to the first virtual object in the preparation interface from an unplanned state to a planned state after the operation on accepting the invitation prompt pop-up window.

15. The computer device according to claim 9, wherein the displaying the preparation interface further comprises:
in response to an operation performed on a second policy control corresponding to the first virtual object in the preparation interface, determining a reference entry position of the fourth virtual object and a reference task confrontation policy matching the reference entry position; and
determining that the first virtual object follows the fourth virtual object into the virtual game scene from the reference entry position in response to a follow authorization of the fourth virtual object by the user of the computer device.

16. The computer device according to claim 15, wherein the method further comprises:
provided feedback information to the fourth virtual object that the first virtual object refuses to follow the fourth virtual object into the virtual game scene from the reference entry position when at least one of the following conditions is met:
when the target scene point is not marked in the scene map; and
when the target scene point is marked in the scene map, but a marked target scene point does not match a reference scene point corresponding to the reference entry position.

17. A non-transitory computer-readable storage medium, storing a stored computer program therein, the computer program, when executed by a processor of the computer device, causing the computer device to perform a method for displaying mark information including:
determining that a first virtual object controlled by a user of the computer device participates in a game task;
displaying a preparation interface before the first virtual object enters a virtual game scene configured for the game task, the preparation interface including a scene map corresponding to the virtual game scene;
after a target scene point in the scene map is marked, displaying entry prompt information matching the target scene point in the preparation interface, the entry prompt information providing an entry position for the first virtual object to enter the virtual game scene and a task confrontation policy matching the entry position; and
in response to an operation performed on an invitation control matching the target scene point, transmitting first entry invitation information to a second virtual object participating in the game task, the first entry invitation information including the target scene point for the second virtual object to follow the first virtual object in the game task.

18. The non-transitory computer-readable storage medium according to claim 17, wherein the displaying entry prompt information matching the target scene point comprises:
determining a region type of a scene region in which the entry position corresponding to the target scene point is located; and
displaying the entry position and the task confrontation policy matching the region type in the preparation interface.

19. The non-transitory computer-readable storage medium according to claim 17, wherein after the transmitting first entry invitation information to a second virtual object participating in the game task, the method further comprises:
controlling the first virtual object to enter the virtual game scene at the entry position;
after the second virtual object determines to follow the first virtual object based on the first entry invitation information, displaying an entry scene interface corresponding to the entry position, the entry scene interface including the first virtual object and the second virtual object following the first virtual object that enter in sequence.

20. The non-transitory computer-readable storage medium according to claim 17, wherein the displaying the preparation interface further comprises:
displaying an invitation prompt pop-up window, the invitation prompt pop-up window including second entry invitation information transmitted by a third virtual object participating in the game task, the second entry invitation information inviting the first virtual object to follow the third virtual object into the virtual game scene;
in response to an operation on accepting the invitation prompt pop-up window, closing the invitation prompt pop-up window, and determining that the first virtual object follows the third virtual object into the virtual game scene.
